(19) United States
(12) Patent Application Publication
(10) Pub. No.: US 2022/0074807 A1
(43) Pub. Date: Mar. 10, 2022

(54) METHOD FOR DETERMINING AN OPTIMAL ARRANGEMENT OF CIRCULAR PIPE SUPPORTS OF STEEL SILO COMPOSITE SHEAR WALL

(71) Applicants: QINGDAO UNIVERSITY OF TECHNOLOGY, Qingdao (CN); QINGDAO SINO UNITED GROUP CO., LTD., Qingdao (CN); QINGDAO EIHE STEEL STRUCTURE CO., LTD., Qingdao (CN)

(72) Inventors: Yousheng YU, Qingdao (CN); Decai YE, Qingdao (CN); Jie LIU, Qingdao (CN); Yonglin YUAN, Qingdao (CN); Xuan WANG, Qingdao (CN); Qilin ZHOU, Qingdao (CN); Dehu YU, Qingdao (CN)

(21) Appl. No.: 17/508,934

(22) Filed: Oct. 22, 2021

Related U.S. Application Data
(63) Continuation of application No. PCT/CN2020/095303, filed on Jun. 10, 2020.

(30) Foreign Application Priority Data
Sep. 6, 2019 (CN) 201910839585.9

(51) Int. Cl. G01M 5/00; E04C 2/28; E04B 2/00; E04H 5/08

(52) U.S. Cl. CPC G01M 5/0041; E04H 5/08; E04C 2/46; E04C 2/28

(57) ABSTRACT

A method for determining an optimal arrangement of circular pipe supports of a steel silo composite shear wall, including: designing a set of steel silo composite shear wall model including parameters of interval of the circular pipe supports, axial-load ratio, steel ratio and aspect ratio: establishing an ABAQUS finite element model including initial defect; performing force analysis by the finite element software ABAQUS and calculating a horizontal ultimate bearing capacity; fitting formulas of the horizontal ultimate bearing capacity of the steel silo composite shear wall by applying least square method; drawing a relationship curve between the interval of the circular pipe supports and the horizontal ultimate bearing capacity; determining the optimal arrangement of the circular pipe supports of the steel silo composite shear wall according to a critical point of the relationship curve between the interval of the circular pipe supports and the horizontal ultimate bearing capacity.

### CROSS-REFERENCE TO RELATED APPLICATIONS

This application is a continuation of International Patent Application No. PCT/CN2020/095303 with a tiling date of Jun. 10, 2020, designating the United States, now pending, and further claims priority to Chinese Patent Application No. 201910839585.9 with a filing date of Sep. 6, 2019. The content of the aforementioned applications, including any intervening amendments thereto, are incorporated herein by reference.

### TECHNICAL FIELD

This disclosure relates to the field of civil engineering, in particular to a method for determining an optimal arrangement of circular pipe supports of a steel silo composite shear wall.

### BACKGROUND

With the development of society, the advancement of science and technology, the improvement of people's living standards, and the gradual improvement of environmental protection requirements, the State Council has comprehensively deployed the development of prefabricated buildings and continuously increased the proportion of prefabricated buildings in new buildings.

The steel silo composite shear wall system is a new type of steel structure system. It is composed of two steel plates and a plurality of circular pipe supports to form a basic unit. The two steel plates at two sides of the unit are supported by circular pipes to form a cavity therebetween. The cavity is poured with concrete to form the composite shear wall, which is used as the main anti-vertical force and anti-lateral force member of the structural system. The steel silo composite shear wall system has the advantages of thin steel pipe wall, economical steel consumption, fast construction speed, simple component production and light weight. However, the interval of the circular pipe supports of the steel silo composite shear wall is only arranged according to experience and the arrangement lacks of theoretical basis. There is no research on the influence of the interval of circular pipe supports on the mechanical properties of steel silo composite shear walls.

### SUMMARY

The present disclosure provides a method for determining an optimal arrangement of circular pipe supports of a steel silo composite shear wall for designing a steel silo composite shear wall.

In order to solve the above technical problem, the present disclosure provides the method including following steps:

S1: designing a set of steel silo composite shear wall models with different parameters; wherein the different parameters include interval of the circular pipe supports, axial-load ratio, steel content and aspect ratio;

S2: establishing an ABAQUS finite element model; wherein element types of steel plate and concrete are both C3D8R type, a tangential force model is Coulomb model, an interface friction coefficient μ=0.25, a normal contact is set as hard contact; steel is connected by Tie constraint; a bottom of the model is fixed constraint, and a horizontal load is applied to a top of the model;

S3: performing nonlinear buckling analysis of members by finite element software ABAQUS to obtain a first-order buckling mode;

S4: introducing an initial defect of the steel silo composite shear wall; wherein defect form of the initial defect takes the first-order buckling mode, and an amplitude is 1/1000 of its height;

S5: performing force analysis by the finite element software ABAQUS to obtain a load-displacement curve of each member;

S6: calculating a horizontal ultimate bearing capacity F of each member according to the load-displacement curve;

S7: fitting formulas (1) and (2) of the horizontal ultimate bearing capacity of the steel silo composite shear wall by applying least square method according to the horizontal ultimate bearing capacity of the steel silo composite shear wall;

$$V = \frac{1}{λ} {( 0.49 + θ )}^{2} {f}_{y} {A}_{s} + \frac{0.2}{λ} {f}_{c} {A}_{c} - 0.01 Z , \qquad ( 1 )$$

wherein: V is the ultimate horizontal bearing capacity; λ is the aspect ratio of the shear wall; f_{c} is an axial compressive strength of the concrete; f_{y} is a yield strength of the steel A_{c} and Aₛ are effective cross-sectional areas of a concrete part and an externally-wrapped steel plate part; Z is an axial pressure borne by the shear wall; θ is an influence coefficient of the interval of the circular pipe supports; in formula (2), when θ≥0.036, θ is taken as 0.0316;

$$θ = 0.008 \times \frac{{ ( \frac{d}{2} )}^{2}}{\sqrt{M \times N}} , \qquad ( 2 )$$

wherein: d is a diameter of each circular pipe support; M is a horizontal interval of the circular pipe supports; N is a longitudinal interval of the circular pipe supports;

S8: drawing a relationship curve between the intervals of the circular pipe supports and the horizontal ultimate bearing capacity V according to formulas (1) and (2);

S9: determining the optimal arrangement of the circular pipe supports of the steel silo composite shear wall according to a critical point of the relationship curve between the intervals of the circular pipe supports and the horizontal ultimate bearing capacity V.

In the method for determining an optimal arrangement of circular pipe supports of a steel silo composite shear wall, wherein a thickness of each circular pipe support of the steel silo composite shear wall, a thickness of a top plate of the externally-wrapped steel plate part and a thickness of a bottom plate of the externally-wrapped steel plate part are the same, and the diameter of each circular pipe support is in a range of 30 mm-80 mm, value ranges of the horizontal interval and the longitudinal interval of the circular pipe supports are both 80 to 300 times of a thickness of the externally-wrapped steel plate.

The beneficial effects of the present disclosure: in the design of the steel silo composite shear wall, the optimal arrangement of the circular pipe supports can effectively improve the horizontal ultimate bearing capacity and non-deformability of the steel silo composite shear wall, and facilitate the production, transportation and installation of elements. The construction is convenient and economical.

### BRIEF DESCRIPTION OF THE DRAWINGS

FIG. 1 is a schematic diagram of a steel silo composite shear wall;

FIG. 2 is a schematic diagram of parameters of the steel silo composite shear wall;

FIG. 3 is a diagram showing load-displacement curves of the steel silo composite shear walls with different intervals of circular pipe supports;

FIG. 4 is a diagram showing load-displacement curves of the steel silo composite shear walls with different axial-load ratios;

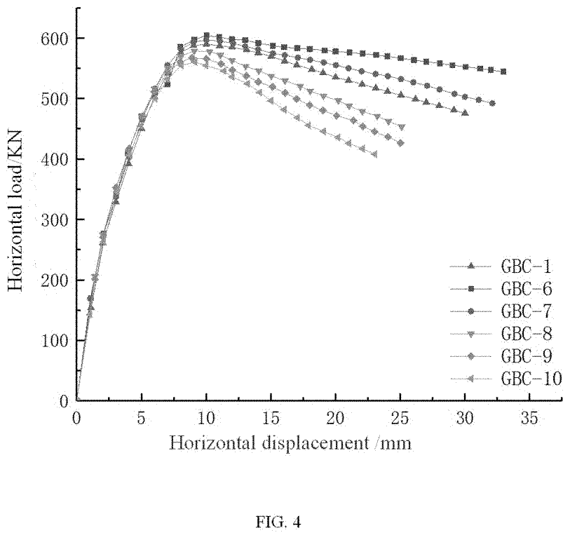

FIG. 5 is a diagram showing load-displacement curves of the steel silo composite shear walls with different steel ratios;

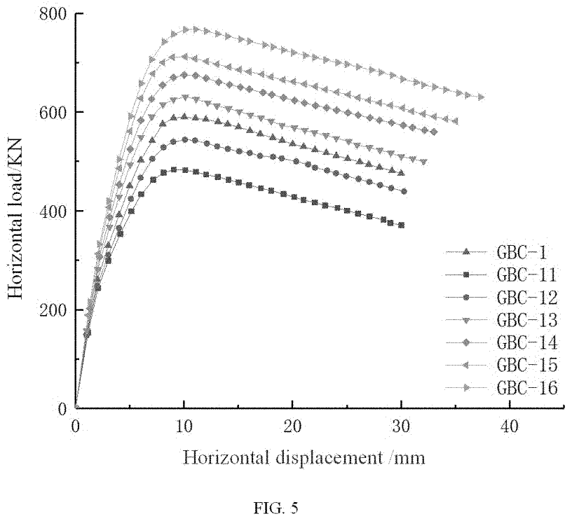

FIG. 6 is a diagram showing load-displacement curves of the steel silo composite shear walls with different aspect ratios;

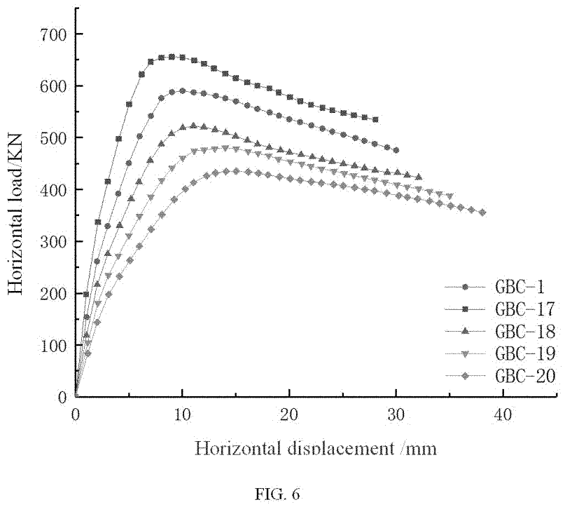

FIG. 7 is a relationship curve between the intervals of the circular pipe supports and the horizontal ultimate bearing capacity V.

### DETAILED DESCRIPTION OF PREFERRED EMBODIMENTS

The present disclosure will be further illustrated below by an embodiment of the optimal arrangement of circular pipe supports of a steel silo composite shear wall with reference to the accompanying drawings, wherein a wall width is set to 1000 mm, a wall height is set to 2000 mm, a wall thickness is set to 130 mm, a steel is Q345B, a concrete is C30.

### Embodiment

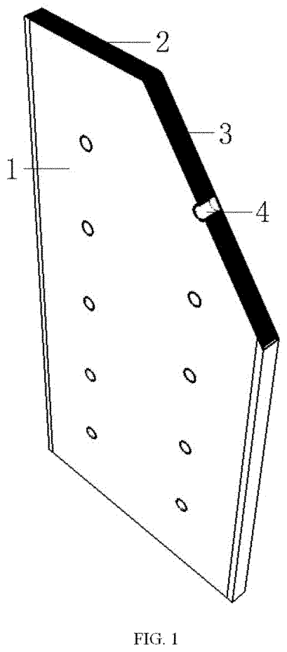

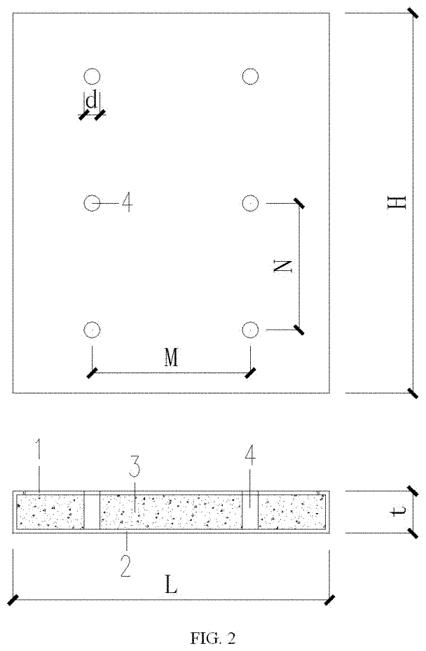

Step 1: designing a set of steel silo composite shear wall models with different parameters. A basic unit is composed of a top plate 1 of an externally-wrapped steel plate, a bottom plate 2 of the externally-wrapped steel plate and circular pipe supports 4. Two steel plates at two sides of the basic unit are supported by circular pipes 4 to form a cavity therebetween. The cavity is poured with concrete 3, as shown in FIGS. 1-2. The parameters include intervals of the circular pipe supports, axial-load ratio, steel content and aspect ratio. GBC-1-GBC-20, the steel is Q345B, the concrete is C30, a diameter d of the circular pipe support is 50 mm, shown in Table 1;

Step 2: establishing an ABAQUS finite element model; wherein element types of steel plate and concrete are both C3D8R type, a tangential force model adopts Coulomb model, an interface friction coefficient μ=0.25, a normal contact is set as hard contact; steel is connected by Tie constraint; a bottom of the model is fixed constraint, and a horizontal load is applied to a top of the model;

Step 3: performing nonlinear buckling analysis of steel silo composite shear wall GBC-1 in an intact state by the finite element software ABAQUS, and a defect form takes a first-order buckling mode;

Step 4: introducing an initial defect, wherein a defect form takes the first-order buckling mode, the amplitude takes 1/1000 of its height;

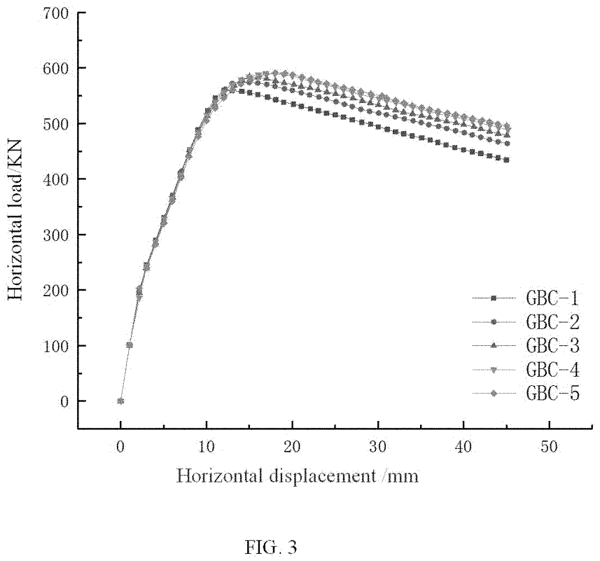

Step 5: performing force analysis of the steel silo composite shear wall GBC-1 by static general method of the finite element software ABAQUS and drawing a load-displacement curve; obtaining load-displacement curves of GBC-1˜GBC-20 by the same method as above, as shown in FIGS. 3˜6;

Step 6: calculating a horizontal ultimate bearing capacity F of each member according to the load-displacement curve;

Step 7: fitting formulas (1) and (2) of the horizontal ultimate bearing capacity of the steel silo composite shear wall by applying least square method according to the horizontal ultimate bearing capacity of the steel silo composite shear wall;

$$V = \frac{1}{λ} {( 0.49 + θ )}^{2} {f}_{y} {A}_{s} + \frac{0.2}{λ} {f}_{c} {A}_{c} - 0.01 Z , \qquad ( 1 )$$

wherein: V is the ultimate horizontal bearing capacity; λ is the aspect ratio of the shear wall; f_{c} is an axial compressive strength of the concrete; f_{y} is a yield strength of the steel; A_{c} and Aₛ are effective cross-sectional areas of a concrete part and an externally-wrapped steel plate part; Z is an axial pressure borne by the shear wall; θ is an influence coefficient of the interval of the circular pipe supports; in formula (2), when θ≥0.036, θ is taken as 0.036;

$$θ = 0.008 \times \frac{{ ( \frac{d}{2} )}^{2}}{\sqrt{M \times N}} , \qquad ( 2 )$$

wherein: d is a diameter of the circular pipe support; M is a horizontal interval of the circular pipe supports; N is a longitudinal interval of the circular pipe supports;

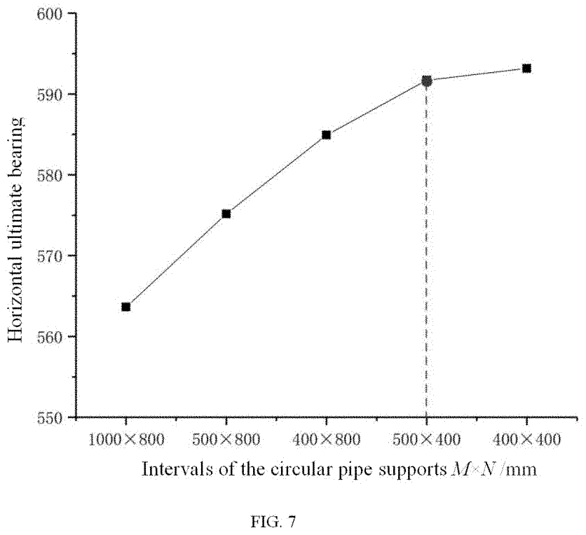

Step 8: drawing a relationship curve between the intervals of the circular pipe supports and the horizontal ultimate bearing capacity V according to formulas (1) and (2); as shown in FIG. 7;

Step 9: according to the relationship curve between the intervals of the circular pipe supports and the horizontal ultimate bearing capacity V, as shown in FIG. 7; when the interval of the circular pipe supports reaches M×N=500 mm 400 mm, the horizontal ultimate bearing capacity of the steel silo composite shear wall is not significantly improved, and the interval of the circular pipe supports of the steel silo composite shear wall M×N rakes 500 mm×400 mm.

TABLE 1
size and calculation results of test piece

| | | | | Steel | | intervals | axial- | | horizontal ultimate | |
|---|---|---|---|---|---|---|---|---|---|---|
| | Wall | Wall | wall | plate | | of circular | load | aspect | bearing capacity/kN | |
| | width | Height | thickness | thickness | steel | pipe | ratio | ratio | numerical | Formula |
| items | L/mm | H/mm | t/mm | t₀/mm | content | M × N/mm | μ | λ | simulation | calculation |
| GBC-1 | 1000 | 2000 | 130 | 4.0 | 6.91% | 1000 × 800 | 0.3 | 2.0 | 559.89 | 563.64 |
| GBC-2 | 1000 | 2000 | 130 | 4.0 | 6.91% | 500 × 800 | 0.3 | 2.0 | 574.71 | 575.15 |
| GBC-3 | 1000 | 2000 | 130 | 4.0 | 6.91% | 400 × 800 | 0.3 | 2.0 | 584.55 | 584.91 |
| GBC-4 | 1000 | 2000 | 130 | 4.0 | 6.91% | 500 × 400 | 0.3 | 2.0 | 589.64 | 591.71 |
| GBC-5 | 1000 | 2000 | 130 | 4.0 | 6.91% | 400 × 400 | 0.3 | 2.0 | 591.03 | 593.16 |
| GBC-6 | 1000 | 2000 | 130 | 4.0 | 6.91% | 500 × 400 | 0.1 | 2.0 | 604.77 | 598.78 |
| GBC-7 | 1000 | 2000 | 130 | 4.0 | 6.91% | 500 × 400 | 0.2 | 2.0 | 597.05 | 587.98 |
| GBC-8 | 1000 | 2000 | 130 | 4.0 | 6.91% | 500 × 400 | 0.4 | 2.0 | 579.08 | 578.37 |
| GBC-9 | 1000 | 2000 | 130 | 4.0 | 6.91% | 500 × 400 | 0.5 | 2.0 | 567.53 | 573.57 |
| GBC-10 | 1000 | 2000 | 130 | 4.0 | 6.91% | 500 × 400 | 0.6 | 2.0 | 560.22 | 568.76 |
| GBC-11 | 1000 | 2000 | 130 | 3.0 | 5.19% | 500 × 400 | 0.3 | 2.0 | 483.25 | 482.37 |
| GBC-12 | 1000 | 2000 | 130 | 3.5 | 6.05% | 500 × 400 | 0.3 | 2,0 | 544.74 | 539.82 |
| GBC-13 | 1080 | 2000 | 130 | 4.5 | 7.76% | 500 × 400 | 0.3 | 2.0 | 630.54 | 633.44 |
| GBC-14 | 1000 | 2000 | 130 | 5.0 | 8.62% | 500 × 400 | 0.3 | 2.0 | 675.20 | 683.61 |
| GBC-15 | 1000 | 2000 | 130 | 5.5 | 9.47% | 500 × 400 | 0.3 | 2.0 | 711.69 | 718.70 |
| GBC-16 | 1000 | 2000 | 130 | 6.0 | 10.32% | 500 × 400 | 0.3 | 2.0 | 767.46 | 783.69 |
| GBC-17 | 1000 | 1800 | 130 | 4.0 | 6.91% | 500 × 400 | 0.3 | 1.8 | 655.50 | 649.57 |
| GBC-18 | 1000 | 2200 | 130 | 4.0 | 6.91% | 500 × 400 | 0.3 | 2.2 | 522.31 | 528.85 |
| GBC-19 | 1000 | 2400 | 130 | 4.0 | 6.91% | 500 × 400 | 0.3 | 2.4 | 480.86 | 483.58 |
| GBC-20 | 1000 | 2600 | 130 | 4.0 | 6.91% | 500 × 400 | 0.3 | 2.6 | 435.30 | 440.27 |

Although the specific embodiments of the present disclosure are described above fit conjunction with the accompanying drawings, the protection scope of the present disclosure is not limited. It should be understood that on the basis of the technical solution of the present disclosure, various modifications or variations that can be made by those skilled in the art without creative work are still within the protection scope of the present disclosure

What is claimed is:

1. A method for determining an optimal arrangement of circular pipe supports of a steel silo composite shear wall, comprising following steps:
S1: designing a set of steel silo composite shear wall models with different parameters; wherein the different parameters comprise interval of the circular pipe supports, axial-load ratio, steel content and aspect ratio;
S2: establishing an ABAQUS finite element model; wherein element types of steel plate and concrete are both C3D8R type, a tangential force model is Coulomb model, an interface friction coefficient μ=0.25, a normal contact is set as hard contact; steel is connected by Tie constraint; a bottom of the model is fixed constraint, and a horizontal load is applied to a top of the model;
S3: performing nonlinear buckling analysis of members by finite element software ABAQUS to obtain a first-order buckling mode;
S4: introducing an initial defect of the steel silo composite shear wall; wherein a form of the initial defect is the first-order buckling mode, and an amplitude is 1/1000 of its height;
S5: performing force analysis by the finite element software ABAQUS to obtain a load-displacement curve of each member;
S6: calculating a horizontal ultimate bearing capacity F of each member according to the load-displacement curve;
S7: fitting formulas (1) and (2) of the horizontal ultimate bearing capacity of the steel silo composite shear wall by applying least square method according to the horizontal ultimate bearing capacity of the steel silo composite shear wall;
$$V = \frac{1}{λ} {( 0.49 + θ )}^{2} {f}_{y} {A}_{s} + \frac{0.2}{λ} {f}_{c} {A}_{c} - 0.01 Z , \qquad ( 1 )$$
wherein: V is the ultimate horizontal bearing capacity; λ is the aspect ratio of the shear wall; f_{c} is an axial compressive strength of the concrete; f_{y} is a yield strength of the steel; A_{c} and Aₛ are effective cross-sectional areas of a concrete part and an externally-wrapped steel plate part; Z is an axial pressure borne by the shear wall; θ is an influence coefficient of the interval of the circular pipe supports; in formula (2), when θ≥0.036, θ is taken as 0.036;
$$θ = 0.008 \times \frac{{ ( \frac{d}{2} )}^{2}}{\sqrt{M \times N}} , \qquad ( 2 )$$
wherein: d is a diameter of each circular pipe support; M is a horizontal interval of the circular pipe supports; N is a longitudinal interval of the circular pipe supports;
S8: drawing a relationship curve between the interval of the circular pipe supports and the horizontal ultimate bearing capacity V according to formulas (1) and (2);
S9: determining the optimal arrangement of the circular pipe supports of the steel silo composite shear wall according to a critical point of the relationship curve between the interval of the circular pipe supports and the horizontal ultimate bearing capacity V.

2. The method of claim 1, wherein, in step S1, a thickness of each circular pipe support of the steel silo composite shear wall, a thickness of a top plate of the externally-wrapped steel plate part are the same as a thickness of a bottom plate of the externally-wrapped steel plate part, and the diameter of each circular pipe support is in a range of 30 mm-80 mm.

3. The method of claim 1, wherein, in step S1, value ranges of the horizontal interval and the longitudinal interval of the circular pipe supports are both 80 to 300 times of a thickness of the externally-wrapped steel plate.
